(19) United States
(12) Patent Application Publication
(10) Pub. No.: US 2025/0235828 A1
(43) Pub. Date: Jul. 24, 2025

(54) LIGHT- AND OXYGEN-PERMEABLE MEMBRANE AND PREPARATION METHOD AND USE THEREOF

(71) Applicants: Tiangong University, Tianjin (CN); Cangzhou Institute of Tiangong University, Cangzhou (CN)

(72) Inventors: Jie WANG, Tianjin (CN); Ying ZHU, Tianjin (CN); Hui JIA, Tianjin (CN)

(73) Assignees: Tiangong University, Tianjin (CN); Cangzhou Institute of Tiangong University, Cangzhou (CN)

(21) Appl. No.: 18/625,220

(22) Filed: Apr. 3, 2024

(30) Foreign Application Priority Data
Jan. 19, 2024 (CN) 202410082599.1

(51) Int. Cl. B01D 67/00; B01D 71/34; B01D 71/70; C02F 3/12

(52) U.S. Cl. CPC B01D 67/0013; B01D 67/0011; B01D 71/34; B01D 71/701; C02F 3/1268; B01D 2323/081; B01D 2323/18; B01D 2323/21817; B01D 2323/219

(57) ABSTRACT

A method for preparing a light- and oxygen-permeable membrane includes: adding polyvinylidene fluoride (PVDF), an organic solvent, and a pore-forming agent successively to a container, stirring at 60° C. to 80° C. for 5 h to 7 h, and conducting vacuum deaeration to obtain a PVDF casting solution; adding polydimethylsiloxane (PDMS) and a curing agent successively to a container, thoroughly stirring at 20° C. to 25° C., and conducting static deaeration to obtain a PDMS casting solution; blade-coating the PVDF casting solution on a glass plate, rinsing the glass plate in a rinsing tank to remove the organic solvent and the pore-forming agent, and oven-drying the glass plate to obtain an initial membrane; and coating the PDMS casting solution on a back side of the initial membrane, placing the initial membrane at room temperature for 2 h to 4 h, and oven-drying the initial membrane to obtain the light- and oxygen-permeable membrane.

### CROSS-REFERENCE TO RELATED APPLICATIONS

This application claims priority to Chinese Patent Application No. 202410082599.1 with a filing date of Jan. 19, 2024. The content of the aforementioned application, including any intervening amendments thereto, is incorporated herein by reference.

### TECHNICAL FIELD

The present disclosure belongs to the field of preparation of water-treatment membranes, and specifically, the present disclosure relates to a light- and oxygen-permeable membrane and a preparation method and use thereof.

### BACKGROUND

The use of an algae-bacteria symbiotic system to treat wastewater has attracted extensive attention. In such an algae-bacteria symbiotic system, under light conditions, microalgae conduct photosynthesis with dissolved organic carbon produced in the algae-bacteria symbiotic system or included in wastewater and nitrogen and phosphorus included in the wastewater to synthesize growth substances required for proliferation of the microalgae and also produce oxygen. In addition, in such an algae-bacteria symbiotic system, aerobic bacteria conduct aerobic respiration with oxygen produced by algae and organic carbon of an electron donor to produce inorganic nutrients required by algae. During such a cyclic utilization process, bacteria and microalgae adsorb and remove pollutants in wastewater while growing themselves. When wastewater is treated with such an algae-bacteria symbiotic system, a disturbance impact caused by aeration will disrupt an interaction between bacteria and algae to limit the photosynthesis, but no aeration will reduce the stability. Membrane aerated biofilm reactors (MABRs) are a wastewater treatment technology that has been widely investigated in recent years. An oxygen transfer mode is one of characteristics of MABRs. In MABRs, oxygen is present in a micro-scale state and does not cause bubbles visible to the naked eyes. When MABR is used in an algae-bacteria symbiotic system, bubble-free aeration is allowed, and the growth of algae can also be prevented from being limited due to a too-high dissolved oxygen level.

In such an algae-bacteria symbiotic system, algae need to be exposed to light for photosynthesis. Most of the current membranes for bubble-free aeration do not have light permeability, and are difficult to transfer light to an inside of an algae-bacteria sludge mixture, which will limit the growth of algae. In order to improve a utilization efficiency of a membrane in an algae-bacteria symbiotic system, the light transmission of the membrane needs to be improved and optimized.

### SUMMARY OF PRESENT INVENTION

In view of this, an objective of the present disclosure is to provide a light- and oxygen-permeable membrane and a preparation method and use thereof. The light- and oxygen-permeable membrane of the present disclosure has a simple structure and exhibits both light and gas permeability. The preparation method of the light- and oxygen-permeable membrane is simple and convenient.

The present disclosure adopts the following technical solutions:

The present disclosure provides a preparation method of a light- and oxygen-permeable membrane, including the following steps:
(1) adding polyvinylidene fluoride (PVDF), an organic solvent, and a pore-forming agent successively to a first container to obtain a first mixture, stirring the first mixture at 60° C. to 80° C. for 5 h to 7 h, and conducting vacuum deaeration to obtain a PVDF casting solution;
(2) adding polydimethylsiloxane (PDMS) and a curing agent successively to a second container to obtain a second mixture, thoroughly stirring the second mixture at 20° C. to 25° C., and conducting static deaeration to obtain a PDMS casting solution;
(3) blade-coating the PVDF casting solution on a first glass plate to obtain a second glass plate, rinsing the second glass plate in a rinsing tank to obtain a third glass plate, and oven-drying the third glass plate to obtain a first initial membrane; and
(4) coating the PDMS casting solution on a back side of the first initial membrane to obtain a second initial membrane, placing the second initial membrane at room temperature for 2 h to 4 h to obtain a third initial membrane, and oven-drying the third initial membrane to obtain the light- and oxygen-permeable membrane.

PVDF and PDMS are adopted as main raw materials in the preparation method of the present disclosure. A PDMS liquid is clear and transparent, and a smooth film formed after curing of the PDMS liquid also has ultra-high optical transparency. PDMS serves as a filling material. The PDMS liquid is filled into pores of a hydrophobic PVDF film to remove voids in the film material, and after the PDMS liquid is cured, a dense composite membrane with a PDMS film as an outer layer and a PVDF film as a support layer can be obtained. The present disclosure eliminates the refraction of light by pores of the PVDF film, and prepares a light- and oxygen-permeable membrane with high optical transparency.

It should be noted that the PDMS in the present disclosure is usually used in combination with a matching curing agent, which can refer to a method in the existing literature. For a convenient operation, a combination of the PDMS and the curing agent can also be purchased from a commercial channel, such as a Xinwei two-component kit product, including PDMS and a curing agent in a mixing ratio of 10:1, which is a commercially-available product; and a Dow Corning SYLGARD DC184 two-component kit product, including PDMS and a curing agent in a mixing ratio of 10:1, which is a commercially-available product.

Preferably, the organic solvent is N,N-dimethylacetamide (DMAC).

In some embodiments, the pore-forming agent is one or more selected from a group consisting of polyvinylpyrrolidone (PVP), lithium chloride, and zinc chloride; and preferably, the pore-forming agent is lithium chloride.

In some embodiments, when the pore-forming agent is the PVP, mass percentages of the PVDF, the organic solvent, and the pore-forming agent in the step (1) are as follows: the PVDF: 12% to 14%, the pore-forming agent of PVP: 3% to 12%, and the organic solvent: the balance.

In some embodiments, when the pore-forming agent is the lithium chloride, mass percentages of the PVDF, the organic solvent, and the pore-forming agent in the step (1) are as follows: the PVDF: 12% to 14%, the pore-forming agent of lithium chloride: 0.4% to 5%, and the organic solvent: the balance.

Preferably, when the pore-forming agent is the lithium chloride, mass percentages of the PVDF, the organic solvent, and the pore-forming agent in the step (1) are as follows: the PVDF: 12% to 14%, the pore-forming agent of lithium chloride: 0.4% to 1%, and the organic solvent: the balance.

In some embodiments, when the pore-forming agent is the zinc chloride, mass percentages of the PVDF, the organic solvent, and the pore-forming agent in the step (1) are as follows: the PVDF: 12% to 14%, the pore-forming agent of zinc chloride: 0.5% to 1%, and the organic solvent: the balance.

In some embodiments, a blade-coating thickness is 300 μm in the step (3).

In some embodiments, the rinsing in the step (3) is conducted as follows: soaking the second glass plate in deionized water at 20° C. to 25° C. until a film is formed.

In some embodiments, the oven-drying in the step (3) is conducted at 30° C. to 40° C. for 30 min to 60 min. In some embodiments, the oven-drying may be conducted in a blast drying oven.

In some embodiments, the PDMS casting solution in the step (4) is coated at an amount of 17 mg/cm² to 25 mg/cm².

In some embodiments, the oven-drying in the step (4) is conducted at 60° C. to 65° C. for 4 h to 6 h. In some embodiments, the oven-drying may be conducted in a blast drying oven.

An embodiment of the present disclosure also provides a light- and oxygen-permeable membrane prepared by the preparation method described above. The light- and oxygen-permeable membrane is processed into a flat plate shape, and has a thickness of 400 μm to 500 μm.

An embodiment of the present disclosure also provides a use of the light- and oxygen-permeable membrane described above in a scenario requiring light irradiation and gas transfer. As an example, the scenario can be an algae-bacteria symbiotic system.

The present disclosure has the following advantages and beneficial effects:
(1) The preparation method of the light- and oxygen-permeable membrane of the present disclosure is simple and can allow large-scale preparation. The light- and oxygen-permeable membrane is specially characterized in that the light- and oxygen-permeable membrane is thin and transparent on the basis of gas permeability. In addition, the preparation method of the light- and oxygen-permeable membrane is universal. Thus, the light- and oxygen-permeable membrane has a high application value in scenarios requiring light irradiation and gas transfer.
(2) The light- and oxygen-permeable membrane of the present disclosure can allow light to effectively irradiate an inside of an algae-bacteria mixed solution, such that bacteria and algae inside a reactor also can grow well and a utilization rate of light is improved.

### BRIEF DESCRIPTION OF THE DRAWINGS

The above and/or additional aspects and advantages of the present disclosure will become apparent and easily understandable from the following descriptions of the embodiments with reference to the accompanying drawings.

FIG. 1 is a schematic structural diagram of a light- and oxygen-permeable membrane in an embodiment of the present disclosure, where A represents a PVDF support layer and B represents a PDMS outer layer;

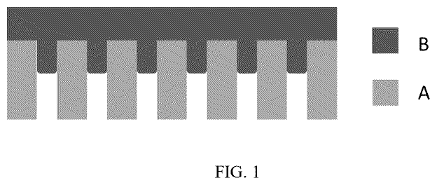

FIG. 2 shows electron microscopy images of the light- and oxygen-permeable membrane prepared in Example 5, where (a) shows a surface of the light- and oxygen-permeable membrane, (b) shows a cross-section of the light- and oxygen-permeable membrane, and (c) shows a distribution of Si in the cross-section of the light- and oxygen-permeable membrane;

FIG. 3 shows appearance of the light- and oxygen-permeable membranes in Examples 1 to 5 and light transmittances of corresponding samples, where (a) shows appearance and transparency effects of the light- and oxygen-permeable membranes, (b) shows light-transmitting effects of the corresponding samples, (c) shows light transmittance data of the corresponding samples, (d) shows illuminance data of the corresponding samples, and (e) shows a test method for (b); and

FIG. 4 shows appearance of the light- and oxygen-permeable membranes in Comparative Examples 1 to 6 and light transmittances of corresponding samples, where (a) shows appearance and transparency effects of the light- and oxygen-permeable membranes and (b) shows light transmittance data of the corresponding samples.

### DETAILED DESCRIPTION OF THE EMBODIMENTS

The embodiments of the present disclosure are described in detail below. The embodiments described below are illustrative, and are intended to explain the present disclosure rather than to limit the present disclosure.

All experimental methods used in the following embodiments are conventional methods, unless otherwise specified.

Unless otherwise specified, the materials, reagents, devices, or the like used in the following embodiments can be obtained from commercial channels or prepared in accordance with methods in public references.

In the present disclosure, when a value is expressed as a range, it should be understood that all possible sub-ranges within this range and specific values falling within this range are included, regardless of whether specific values or specific sub-ranges are explicitly indicated.

Unless otherwise defined, all technical and scientific terms used herein have meanings normally understood by those skilled in the field to which the present disclosure belongs.

The term “and/or” herein merely describes an association relationship between associated objects, and indicates that three types of relationships may exist. For example, A and/or B may indicate that A exists alone, A and B coexist, or B exists alone.

The term “about” herein refers to a deviation of +/−10% from a listed value.

The present disclosure provides a preparation method of a light- and oxygen-permeable membrane, including the following steps:
(1) PVDF, an organic solvent, and a pore-forming agent are added successively to a first container, stirred at 60° C. to 80° C. for 5 h to 7 h, and subjected to vacuum deaeration to obtain a PVDF casting solution;
(2) PDMS and a curing agent are added successively to a second container, thoroughly stirred at 20° C. to 25° C., and subjected to static deaeration to obtain a PDMS casting solution;
(3) the PVDF casting solution is blade-coated on a first glass plate to obtain a second glass plate, and the second glass plate is rinsed in a rinsing tank and then oven-dried to obtain a first initial membrane; and
(4) the PDMS casting solution is coated on a back side of the first initial membrane to obtain a second initial membrane, and the second initial membrane is placed at room temperature for 2 h to 4 h and then oven-dried to obtain the light- and oxygen-permeable membrane.

It should be noted that the PDMS in the present disclosure is usually used in combination with a matching curing agent, which can refer to a method in the existing literature. For a convenient operation, a combination of the PDMS and the curing agent can also be purchased from a commercial channel, such as a Xinwei two-component kit product, including PDMS and a curing agent in a mixing ratio of 10:1, which is a commercially-available product; and a Dow Corning SYLGARD DC184 two-component kit product, including PDMS and a curing agent in a mixing ratio of 10:1, which is a commercially-available product.

In the preparation method of the embodiment of the present disclosure, non-restrictive examples are as follows:

In the step (1), the stirring can be conducted at 60° C., 65° C., 70° C., 75° C., 80° C., or the like, and the stirring can be conducted for 5 h, 5.5 h, 6 h, 6.5 h, 7 h, or the like.

In the step (2), the stirring can be conducted at 20° C., 22° C., 23° C., 24° C., 25° C., or the like.

In the step (4), the second initial membrane can be placed at room temperature for 2 h, 2.2 h, 3 h, 3.5 h, 4 h, or the like.

Preferably, the organic solvent is DMAC.

In some embodiments, the pore-forming agent is one or more selected from a group consisting of PVP, lithium chloride, and zinc chloride. As a non-restrictive example, the pore-forming agent is PVP, lithium chloride, zinc chloride, a combination of PVP and lithium chloride, a combination of PVP and zinc chloride, a combination of lithium chloride and zinc chloride, or a combination of PVP, lithium chloride, and zinc chloride. More preferably, the pore-forming agent is lithium chloride.

In some embodiments, when the pore-forming agent is the PVP, mass percentages of the PVDF, the organic solvent, and the pore-forming agent in the step (1) are as follows: the PVDF: 12% to 14%, the pore-forming agent of PVP: 3% to 12%, and the organic solvent: the balance. As a non-restrictive example, a mass percentage of the PVDF can be 12%, 12.5%, 13%, 13.5%, 14%, or the like, a mass percentage of the pore-forming agent of PVP can be 3%, 5%, 6%, 8%, 12%, or the like, and a mass percentage of the organic solvent accounts for the balance.

In some embodiments, when the pore-forming agent is the lithium chloride, mass percentages of the PVDF, the organic solvent, and the pore-forming agent in the step (1) are as follows: the PVDF: 12% to 14%, the pore-forming agent of lithium chloride: 0.4% to 5%, and the organic solvent: the balance. As a non-restrictive example, a mass percentage of the PVDF can be 12%, 12.5%, 13%, 13.5%, 14%, or the like, a mass percentage of the pore-forming agent of lithium chloride can be 0.4%, 1%, 2%, 3%, 4%, 5%, or the like, and a mass percentage of the organic solvent accounts for the balance.

In some embodiments, when the pore-forming agent is the zinc chloride, mass percentages of the PVDF, the organic solvent, and the pore-forming agent in the step (1) are as follows: the PVDF: 12% to 14%, the pore-forming agent of zinc chloride: 0.5% to 1%, and the organic solvent: the balance. As a non-restrictive example, a mass percentage of the PVDF can be 12%, 12.5%, 13%, 13.5%, 14%, or the like, a mass percentage of the pore-forming agent of zinc chloride can be 0.5%, 0.6%, 0.8%, 0.9%, 1%, or the like, and a mass percentage of the organic solvent accounts for the balance.

In some embodiments, a blade-coating thickness is 300 μm in the step (3).

In some embodiments, the rinsing in the step (3) is conducted as follows: the second glass plate is soaked in deionized water at 20° C. to 25° C. until a film is formed. As a non-restrictive example, a temperature of the deionized water can be 20° C., 22° C., 23° C., 24° C., 25° C., or the like.

In some embodiments, the oven-drying in the step (3) is conducted at 30° C. to 40° C. for 30 min to 60 min. In some embodiments, the oven-drying may be conducted in a blast drying oven. As a non-restrictive example, the oven-drying can be conducted at 30° C., 32° C., 35° C., 38° C., 40° C., or the like, and the oven-drying can be conducted for 30 min, 35 min, 45 min, 50 min, 60 min, or the like.

In some embodiments, the PDMS casting solution in the step (4) is coated at an amount of 17 mg/cm² to 25 mg/cm². As a non-restrictive example, the PDMS casting solution can be coated at an amount of 17 mg/cm², 18.5 mg/cm², 20 mg/cm², 22 mg/cm², 25 mg/cm², or the like.

In some embodiments, the oven-drying in the step (4) is conducted at 60° C. to 65° C. for 4 h to 6 h. In some embodiments, the oven-drying may be conducted in a blast drying oven. As a non-restrictive example, the oven-drying can be conducted at 60° C., 61° C., 62° C., 64° C., 65° C., or the like, and the oven-drying can be conducted for 4 h, 4.5 h, 5 h, 5.5 h, 6 h, or the like.

An embodiment of the present disclosure also provides a light- and oxygen-permeable membrane prepared by the preparation method described above. The light- and oxygen-permeable membrane is processed into a flat plate shape, and has a thickness of 400 μm to 500 μm. As a non-restrictive example, the light- and oxygen-permeable membrane can have a thickness of 400 μm, 420 μm, 450 μm, 480 μm, 500 μm, or the like.

An embodiment of the present disclosure also provides a use of the light- and oxygen-permeable membrane described above in a scenario requiring light irradiation and gas transfer. As an example, the scenario can be an algae-bacteria symbiotic system.

In the examples and comparative examples of the present disclosure, product sources are as follows:
PVDF: purchased from Solvay, France, model: Solef6010.
PDMS and a curing agent: a Dow Corning SYLGARD DC184 two-component kit product including PDMS and a curing agent in a mixing ratio of 10:1, which is a commercially-available product.

In the present disclosure:

### Scanning Electron Microscopy (SEM)

SEM is used mainly to characterize a morphology of a light- and oxygen-permeable membrane and a morphology and compactness of a layer of a light- and oxygen-permeable membrane. A scanning electron microscope used in the present disclosure is a Regulus 8100 scanning electron microscope of Hitachi, Japan. Before a sample is tested, in order to retain a true structure of the sample, a membrane sample is broken through quenching in liquid nitrogen to obtain a cross-section sample from the membrane sample, and then the cross-section sample needs to be sprayed with gold to enhance its electrical conductivity.

### Energy-Dispersive X-Ray Spectroscopy (EDX)

EDX is used mainly to analyze relative contents and distributions of elements in a layer of a light- and oxygen-permeable membrane. An EDX spectrometer used in the present disclosure is Ultim Max 65 of Oxford Instruments in the United Kingdom. The EDX spectrometer is attached to the scanning electron microscope. A sample needs to be sprayed with gold, then fixed on a sample tray by a conductive adhesive, and then tested at a working voltage of 20 kV.

Specific examples and comparative examples of the present disclosure are provided below. It should be noted that technical solutions in the following comparative examples are not the prior arts, and are provided merely for comparison with the solutions in the examples, but are not intended to limit the present disclosure.

### Example 1

A preparation method of a light- and oxygen-permeable membrane was provided, including the following steps:

12 wt % of PVDF, 85 wt % of DMAC, and 3 wt % of PVP were added successively to a first mixing tank, stirred at 70° C. for 7 h, and subjected to vacuum deaeration to obtain a PVDF casting solution.

10 g of PDMS and 1 g of a curing agent were added successively to a second mixing tank, thoroughly stirred at 25° C., and subjected to static deaeration to obtain a PDMS casting solution.

The PVDF casting solution was blade-coated on a first glass plate with a blade-coating thickness of 300 μm to obtain a second glass plate, and then the second glass plate was soaked in a rinsing tank with deionized water at 20° C. until a film was formed (about 1 min to 2 min) to remove the organic solvent and the pore-forming agent, and then dried at 35° C. for 1 h in a blast drying oven to obtain a first initial membrane.

The PDMS casting solution was coated at a coating amount of 24.2 mg/cm² on a back side of the first initial membrane to obtain a second initial membrane, and the second initial membrane was placed at room temperature for 4 h and then oven-dried at 60° C. for 4 h in a blast drying oven to obtain the light- and oxygen-permeable membrane with a thickness of about 450 μm.

### Example 2

A preparation method of a light- and oxygen-permeable membrane was provided, including the following steps:

12 wt % of PVDF, 87.6 wt % of DMAC, and 0.4 wt % of lithium chloride were added successively to a first mixing tank, stirred at 60° C. for 7 h, and subjected to vacuum deaeration to obtain a PVDF casting solution.

10 g of PDMS and 1 g of a curing agent were added successively to a second mixing tank, thoroughly stirred at 25° C., and subjected to static deaeration to obtain a PDMS casting solution.

The PVDF casting solution was blade-coated on a first glass plate with a blade-coating thickness of 300 μm to obtain a second glass plate, and then the second glass plate was soaked in a rinsing tank with deionized water at 20° C. until a film was formed to remove the organic solvent and the pore-forming agent, and then dried at 35° C. for 1 h in a blast drying oven to obtain a first initial membrane.

The PDMS casting solution was coated at a coating amount of 17.1 mg/cm² on a back side of the first initial membrane to obtain a second initial membrane, and the second initial membrane was placed at room temperature for 2 h and then oven-dried at 60° C. for 6 h in a blast drying oven to obtain the light- and oxygen-permeable membrane with a thickness of about 450 μm.

### Example 3

A preparation method of a light- and oxygen-permeable membrane was provided, including the following steps:

12 wt % of PVDF, 87 wt % of DMAC, and 1 wt % of zinc chloride were added successively to a first mixing tank, stirred at 60° C. for 7 h, and subjected to vacuum deaeration to obtain a PVDF casting solution.

10 g of PDMS and 1 g of a curing agent were added successively to a second mixing tank, thoroughly stirred at 25° C., and subjected to static deaeration to obtain a PDMS casting solution.

The PVDF casting solution was blade-coated on a first glass plate with a blade-coating thickness of 300 μm to obtain a second glass plate, and then the second glass plate was soaked in a rinsing tank with deionized water at 20° C. until a film was formed to remove the organic solvent and the pore-forming agent, and then dried at 35° C. for 1 h in a blast drying oven to obtain a first initial membrane.

The PDMS casting solution was coated at a coating amount of 17.8 mg/cm² on a back side of the first initial membrane to obtain a second initial membrane, and the second initial membrane was placed at room temperature for 2 h and then oven-dried at 60° C. for 6 h in a blast drying oven to obtain the light- and oxygen-permeable membrane with a thickness of about 450 μm.

### Example 4

This example was different from Example 2 merely in that a mass percentage of PVDF was 14 wt %, a mass percentage of DMAC was 85 wt %, and a mass percentage of lithium chloride was 1 wt %.

### Example 5

This example was different from Example 4 merely in that the second initial membrane was placed at room temperature for 3 h.

### Comparative Example 1

A preparation method of a light- and oxygen-permeable membrane was provided, including the following steps:

12 wt % of PVDF, 87.6 wt % of DMAC, and 0.4 wt % of lithium chloride were added successively to a first mixing tank, stirred at 60° C. for 7 h, and subjected to vacuum deaeration to obtain a PVDF casting solution.

10 g of PDMS and 1 g of a curing agent were added successively to a second mixing tank, thoroughly stirred at 25° C., and subjected to static deaeration to obtain a PDMS casting solution.

The PVDF casting solution was blade-coated on a first glass plate with a blade-coating thickness of 300 μm to obtain a second glass plate, and then the second glass plate was soaked in a rinsing tank with deionized water at 20° C. until a film was formed to remove the organic solvent and the pore-forming agent, and then dried at 35° C. for 1 h in a blast drying oven to obtain a first initial membrane.

The PDMS casting solution was coated at a coating amount of 17 mg/cm² on a front side of the first initial membrane to obtain a second initial membrane, and the second initial membrane was placed at room temperature for 2 h and then oven-dried at 60° C. for 6 h in a blast drying oven to obtain the light- and oxygen-permeable membrane with a thickness of about 450 μm.

### Comparative Example 2

This comparative example was different from Example 2 merely in that the second initial membrane was placed at room temperature for 2 min.

### Comparative Example 3

This comparative example was different from Example 2 merely in that the second initial membrane was placed at room temperature for 10 min.

### Comparative Example 4

This comparative example was different from Example 2 merely in that the second initial membrane was placed at room temperature for 30 min.

### Comparative Example 5

This comparative example was different from Example 2 merely in that the second initial membrane was placed at room temperature for 60 min.

### Comparative Example 6

A preparation method of a light- and oxygen-permeable membrane was provided, including the following steps:

15 wt % of PVDF, 83.5 wt % of DMAC, and 1.5 wt % of lithium chloride were added successively to a first mixing tank, stirred at 60° C. for 4 h, subjected to vacuum deaeration, and naturally-cooled to room temperature to obtain a first casting solution.

1.5 g of PDMS was mixed with 4.5 g of the first casting solution in a second mixing tank and stirred at 25° C. for 4 h, 0.15 g of a curing agent was added to the second mixing tank to obtain a mixture, and the mixture was stirred at 25° C. for 0.5 h and then subjected to vacuum deaeration to obtain a second casting solution.

The second casting solution was blade-coated on a first glass plate with a blade-coating thickness of 300 μm to obtain a second glass plate. The second glass plate was placed for 40 s, and then soaked in a rinsing tank with deionized water at 20° C. until a film was formed to remove the organic solvent to obtain a light- and oxygen-permeable membrane. The light- and oxygen-permeable membrane was dried for later use.

The above light- and oxygen-permeable membrane products each were tested, and test results were shown in Table 1.
(1) A test method for an oxygen transfer rate (OTR): An oxygen mass transfer coefficient (K_{La}) and OTR of an aeration membrane were calculated according to a method in “Chemical Deoxygenation Method for Testing Oxygenation Performance of Aerator for Clear Water” (DB37/T 2667-2015).

A calculation formula for a total oxygen transfer coefficient K_{LaT}:

$$ln ( {C}_{s , τ} - C ) = ln C - {K}_{L a T} \times t \qquad ( 1 )$$

Where K_{LaT} represents a total oxygen transfer coefficient of an aerator in clear water at a test water temperature, h⁻¹; C_{S,T} represents an oxygen saturation, mg/L; C represents a corresponding dissolved oxygen concentration in water at an aeration time point t, mg/L; and t represents any time point during an aeration test, h.

A calculation formula for a standard total oxygen transfer coefficient k_{La (20)}:

$${K}_{L a ( 20 )} = {K}_{L a ( T )} / 1.02 {4}^{( T - 20 )} \qquad ( 2 )$$

where K_{La (T)} represents a total oxygen transfer coefficient at a water temperature T, h⁻¹; K_{La (20)} represents a total oxygen transfer coefficient at a water temperature of 20° C., h⁻¹; and T represents a design temperature, ° C.

A dissolved oxygen saturation C_{S,T} determined at T° C. during a clear water test was converted into C_{S,20}, which could be calculated with a standard oxygen saturation and an actual atmospheric pressure P according to the following formula:

$${C}_{S , 20} = {C}_{S , T} \times \frac{{C}_{S , S , 20}}{{C}_{S , S , T}} \times \frac{0.1013}{P} \qquad ( 3 )$$

where C_{S,20} represents a saturated dissolved oxygen concentration in clear water at 20° C., mg/L; C_{S,T} represents an oxygen saturation, mg/L; C_{S,S,20} represents a standard saturated dissolved oxygen concentration at 20° C., mg/L, as shown in Appendix B; C_{S,S,T} represents a standard oxygen saturation, mg/L, as shown in Appendix B; 0.1013 represents a standard atmospheric pressure, MPa; and P represents an actual atmospheric pressure during a test, MPa.

A calculation formula for a standard oxygen transfer rate (SOTR):

$$SOTR = \frac{{K}_{La 20} {C}_{S , 20} \cdot V}{1000} \qquad ( 4 )$$

where SOTR represents a standard oxygen transfer rate, kg/h; K_{La20} represents a total oxygen transfer coefficient of an aerator during a clear water test under standard state test conditions, h⁻¹; C_{S,20} represents a saturated dissolved oxygen concentration in clear water at 20° C., mg/L; and V represents a volume of water in a test pool, m³.

### (2) Test Methods for a Light Transmittance and a Haze

Determination of Light Transmittance and Haze of Transparent Plastics (GB/T2410-2008)

Standard Test Methods for Haze and Light Transmittance of Transparent Plastics (D1003-13)

An ultraviolet-visible spectrophotometer was used to characterize optical properties of a membrane: a light transmittance and a haze. A wavelength range of a light source of the spectrophotometer was set as 400 nm to 800 nm. Membrane samples of a same thickness were adopted to exclude the influence of a sample thickness on light transmittance and haze data. Membrane samples were cut to a same size, fixed on clips specifically designed for testing the membrane samples, and tested in an ultraviolet-visible spectrophotometer equipped with an integrating sphere accessory. The light transmittance and the haze were calculated by the following formulas, respectively:

$$Light transmittance ( \% ) = \frac{{T}_{1}}{{T}_{2}} \times 100 \%$$

$$Haze ( \% ) = ( \frac{{T}_{4} - {T}_{3}}{{T}_{2} - {T}_{1}} ) \times 100 \%$$

where T₁ represents a flux of incident light, T₂ represents a flux of total light transmitted through a sample, T₃ represents a flux of light scattered by an instrument, and T₄ represents a flux of light scattered by an instrument and a sample.

TABLE 1

| Sample | OTR | Light transmittance |
|---|---|---|
| Example 1 | 10.10 g/m² · h | 85% |
| Example 2 | 6.85 g/m² · h | 81% |
| Example 3 | 3.21 g/m² · h | 85% |
| Example 4 | 4.08 g/m² · h | 97% |
| Example 5 | 4.17 g/m² · h | 91% |
| Comparative Example 1 | 3.13 g/m² · h | 15% |
| Comparative Example 2 | — | 18% |
| Comparative Example 3 | — | 27% |
| Comparative Example 4 | — | 39% |
| Comparative Example 5 | — | 57% |
| Comparative Example 6 | — | 16% |

It can be seen from OTR and light transmittance data of Examples 1 to 5 and Comparative Examples 1 to 6 in Table 1 that the preparation method provided by the present disclosure is simple, and can lead to a light- and oxygen-permeable membrane with high oxygen permeability and high light permeability.

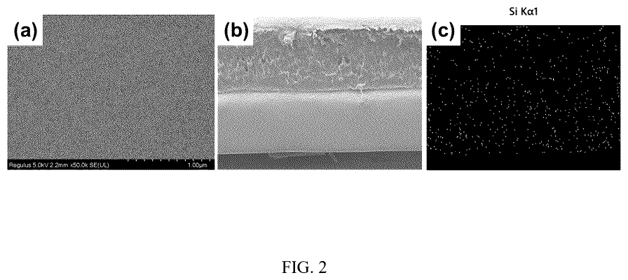

FIG. 2 shows electron microscopy images of the light- and oxygen-permeable membrane prepared in Example 5. It can be seen from (a) in FIG. 2 that a surface of the light- and oxygen-permeable membrane has a stable and dense structure and is relatively smooth. (b) in FIG. 2 shows a cross-section of the light- and oxygen-permeable membrane. It can be seen from (b) in FIG. 2 that PDMS is uniformly coated on a PVDF film to form a dense layer (PDMS layer) with a thickness of about 150 μm. (c) in FIG. 2 shows a distribution of Si in the cross-section of the light- and oxygen-permeable membrane. It can be seen from (c) in FIG. 2 that Si have been evenly penetrated into the PVDF film.

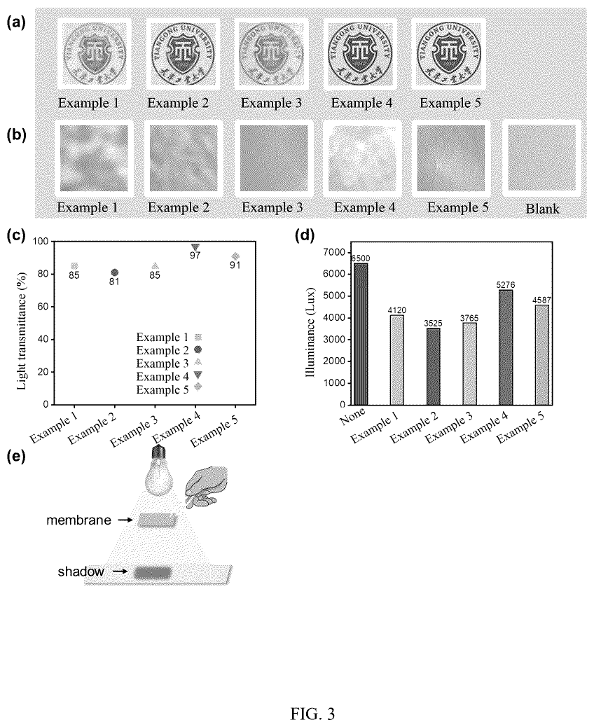

FIG. 3 shows appearance of the light- and oxygen-permeable membranes in Examples 1 to 5 and light transmittances of corresponding samples. In FIG. 3, (a) shows appearance and transparency effects of the light- and oxygen-permeable membranes, (b) shows light-transmitting effects of the corresponding samples, (c) shows light transmittance data of the corresponding samples, (d) shows illuminance data of the corresponding samples, and (d) shows a test method for (b). Light transmittance degrees of the membranes in the examples can be seen in FIG. 3. In the examples, PVP, lithium chloride, and zinc chloride are used as pore-forming agents, and these pore-forming agents all can make the filler of PDMS well penetrate into film pores. As a result, light transmittances of the light- and oxygen-permeable membranes in the examples all can reach 80% or more, and illuminances of an LED lamp with an illuminance of 6,500 Lux after passing through the membranes in the examples can still reach 3,500 Lux or more.

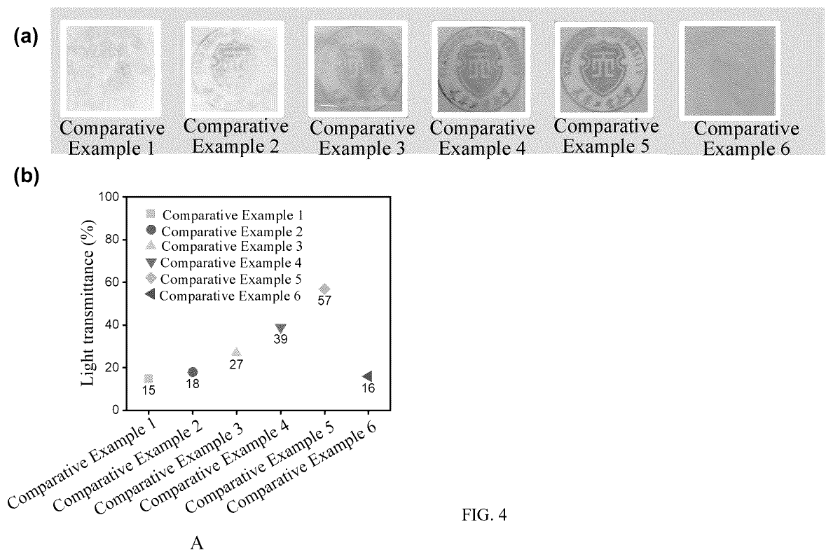

FIG. 4 shows appearance of the light- and oxygen-permeable membranes in Comparative Examples 1 to 6 and light transmittances of corresponding samples, where (a) shows appearance and transparency effects of the light- and oxygen-permeable membranes and (b) shows light transmittance data of the corresponding samples. It can be seen from FIG. 4 that a too-short standing time after coating has a great impact on a light transmittance of a membrane, and methods such as coating on a front side of a membrane, a too-short coating time, and blending cannot improve a light transmittance of a membrane.

In the present disclosure, the terms such as “an embodiment”, “some embodiments”, “an example”, “a specific example”, and “some examples” mean that specific features, structures, materials, or characteristics described with reference to the embodiments or examples are included in at least one embodiment or example of the present disclosure. In this specification, the schematic expression of the above terms is not necessarily directed to the same embodiment or example. Moreover, the specific features, structures, materials, or characteristics described may be combined in a suitable manner in any one or more embodiments or examples. In addition, those skilled in the art may combine different embodiments or examples described in this specification and characteristics of the different embodiments or examples without any contradiction.

Although the embodiments of the present disclosure have been illustrated and described above, it will be appreciated that the above embodiments are illustrative and should not be construed as limiting the present disclosure. Changes, modifications, substitutions, and variations can be made to the above embodiments by a person of ordinary skill in the art within the scope of the present disclosure.

What is claimed is:

1. A method for preparing a light- and oxygen-permeable membrane, comprising the following steps:
(1) adding polyvinylidene fluoride (PVDF), an organic solvent, and a pore-forming agent successively to a first container to obtain a first mixture, stirring the first mixture at 60° C. to 80° C. for 5 h to 7 h, and conducting vacuum deaeration to obtain a PVDF casting solution;
(2) adding polydimethylsiloxane (PDMS) and a curing agent successively to a second container to obtain a second mixture, thoroughly stirring the second mixture at 20° C. to 25° C., and conducting static deaeration to obtain a PDMS casting solution;
(3) blade-coating the PVDF casting solution on a first glass plate to obtain a second glass plate, rinsing the second glass plate in a rinsing tank to obtain a third glass plate, and oven-drying the third glass plate to obtain a first initial membrane; and
(4) coating the PDMS casting solution on a back side of the first initial membrane to obtain a second initial membrane, placing the second initial membrane at room temperature for 2 h to 4 h to obtain a third initial membrane, and oven-drying the third initial membrane to obtain the light- and oxygen-permeable membrane.

2. The method according to claim 1, wherein the organic solvent is N,N-dimethylacetamide (DMAC).

3. The method according to claim 1, wherein the pore-forming agent is one or more selected from a group consisting of polyvinylpyrrolidone (PVP), lithium chloride, and zinc chloride; and preferably, the pore-forming agent is lithium chloride.

4. The method according to claim 3, wherein
when the pore-forming agent is the PVP, mass percentages of the PVDF, the organic solvent, and the pore-forming agent in the step (1) are as follows: the PVDF: 12% to 14%, the pore-forming agent of PVP: 3% to 12%, and the organic solvent: the balance;
when the pore-forming agent is the lithium chloride, mass percentages of the PVDF, the organic solvent, and the pore-forming agent in the step (1) are as follows: the PVDF: 12% to 14%, the pore-forming agent of lithium chloride: 0.4% to 5%, and the organic solvent: the balance; and
when the pore-forming agent is the zinc chloride, mass percentages of the PVDF, the organic solvent, and the pore-forming agent in the step (1) are as follows: the PVDF: 12% to 14%, the pore-forming agent of zinc chloride: 0.5% to 1%, and the organic solvent: the balance.

5. The method according to claim 1, wherein a blade-coating thickness is 300 μm in the step (3).

6. The method according to claim 1, wherein
the rinsing in the step (3) is conducted as follows: soaking the second glass plate in deionized water at 20° C. to 25° C. until a film is formed; and/or
the oven-drying in the step (3) is conducted at 30° C. to 40° C. for 30 min to 60 min.

7. The method according to claim 1, wherein the PDMS casting solution in the step (4) is coated at an amount of 17 mg/cm² to 25 mg/cm².

8. The method according to claim 1, wherein the oven-drying in the step (4) is conducted at 60° C. to 65° C. for 4 h to 6 h.

9. A light- and oxygen-permeable membrane prepared by the preparation method according to claim 1.

10. An application of the light- and oxygen-permeable membrane according to claim 9, comprising: using the light- and oxygen-permeable membrane in a scenario requiring light irradiation and gas transfer.
